(19) United States
(12) Patent Application Publication
(10) Pub. No.: US 2016/0267681 A1
(43) Pub. Date: Sep. 15, 2016

(54) Creative Color Design

(71) Applicant: International Business Machines Corporation, Armonk, NY (US)

(72) Inventors: Ying Li, Mohegan Lake, NY (US); Anshul Sheopuri, Teaneck, NJ (US)

(21) Appl. No.: 14/745,584

(22) Filed: Jun. 22, 2015

Related U.S. Application Data
(63) Continuation of application No. 14/644,682, filed on Mar. 11, 2015.

(51) Int. Cl. G06T 7/40; G06T 11/00; G06Q 30/02; G06T 11/20

(52) U.S. Cl. CPC G06T 7/408; G06T 11/206; G06T 11/001; G06Q 30/0201; G06T 2207/10024; G06T 2207/20081; G06T 2207/20072

(57) ABSTRACT

A mechanism is provided for generating a set of color palettes for a product to be marketed. Color-related information of each image in a set of images is extracted. Using a user provided targeted product, targeted brand, and targeted brand message(s) to be marketed, computational logic is applied to generate a set of new color palettes for use in product design or product packaging design. The set of new color palettes is presented to the user. Responsive to the user selecting a color palette from the set of new color palettes, a color analysis of the selected color palette is performed. The results of the color analysis are then presented to the user.

### BACKGROUND

The present application relates generally to an improved data processing apparatus and method and more specifically to mechanisms for creative color design.

Everything around us conveys a message, no matter if it is a company logo, a product package, or the clothes that we wear. Currently, such designs are mainly driven by the intuition and experiences of human designers, with colors in the design being one of the most important design aspects. That is, according to different studies, people make up their minds within 90 seconds of their initial interactions with products, and about 62-90% of such assessment is based on colors alone. Therefore, prudent use of colors can not only differentiate products from competitors, but also influence customers' moods and feelings, and consequently, steer their attitudes towards certain products.

That is, color is the most instantaneous and wonderful means for delivering and communicating messages and meanings to an intended audience. Much of the reaction to color is subtle, triggered by tiny nerve ending and chemicals in the brain that excite, sadden, overwhelm, or inspire a viewer, when coming in contact with various colors. Different hues and saturation levels may convey elegance, creativity, and seriousness, while others convey experience, excitement, vitality, and dependability. Thus, color is important to everyone who wants to convey a message.

Moreover, color also serves as the best way to reflect and enhance a unified image and branding of a company's products. For instance, a company who wants to send a message of professional and seriousness to consumers, will likely use very different packaging colors for its products than those used by companies whose products are more about health and wellbeing. Thus, colors are an effective means of attracting attention, creating aesthetic experiences, and delivering communication of quality and brand identity.

### SUMMARY

In one illustrative embodiment, a method, in a data processing system, is provided for generating a set of color palettes for a product. The illustrative embodiment extracts color-related information of each image in a set of images. The illustrative embodiment applies computational logic to generate a set of new color palettes for use in product design or product packaging design using a user provided targeted product, targeted brand, and targeted brand message(s) to be marketed. The illustrative embodiment presents the set of new color palettes to the user. The illustrative embodiment performs a color analysis of the selected color palette in response to the user selecting a color palette from the set of new color palettes. The illustrative embodiment presents results of the color analysis to the user.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a functional block diagram of a creative color design mechanism in accordance with an illustrative embodiment;

FIG. 4 depicts an example of the color composition information extraction process in accordance with an illustrative embodiment;

FIG. 5 depicts one example of a color-message graph in accordance with an illustrative embodiment;

FIG. 6 depicts an exemplary operation performed in generating the set of new color palettes in accordance with an illustrative embodiment;

FIG. 7 depicts one example of the possible color combinations that are generated in accordance with an illustrative embodiment;

FIG. 8 depicts one example of the color analysis associated with a selected color palette in accordance with an illustrative embodiment;

FIG. 9 depicts a flowchart of the operation performed by the creative color design mechanism in accordance of the illustrative embodiments;

FIG. 10 depicts a flowchart of the operation performed by the creative color design mechanism in generating the set of new color palettes in accordance of the illustrative embodiments; and

FIG. 11 depicts a flowchart of the operation performed by the creative color design mechanism in analyzing the set of new color palettes in accordance of the illustrative embodiments.

### DETAILED DESCRIPTION

In order to foster creative design of product packaging by creating new color palettes, which are not only visually appealing, but also novel and consistent with the desired messages for a given brand and product, the illustrative embodiments provide mechanisms that generate numerous new color palette possibilities and identify smaller sets of color palettes for the design of new and/or existing products based on the measures of spreadness, colorfulness, and surprise. Based on the colors contained in each color palette, a determination is made as to whether the messages being conveyed by the color palette is consistent or conflicting with the desired brand message. This determination is established using a rich network of relationships between messages and colors based on color psychology. A large set of images of various brands, products, as well as images from other domains are used as inspiration to generate numerous new color palettes.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

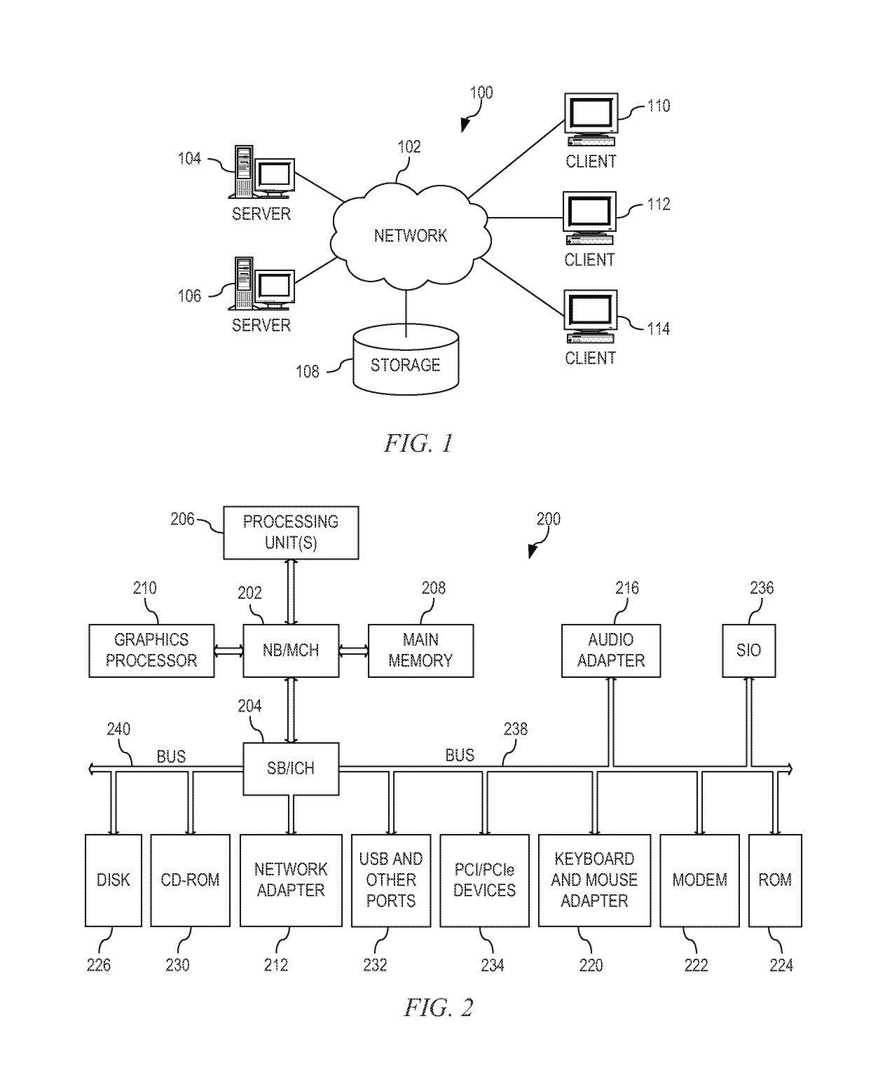

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System P® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

In order to assist enterprises and companies with product and product packaging designs, the illustrative embodiments provide color palettes that are visually appealing, novel, and consistent with desired marketing messages for a particular brand and product. The mechanisms of the illustrative embodiments start with mining of large collections of images of different products and brands to learn about all the colors and color combinations that frequently appear among the products and brands. The mechanisms construct a color-message graph to represent messages conveyed by colors detected in a set of images as well as to capture the interrelationship among the messages, such as synonymic and antonymic relationships. Knowledge from both color psychology and information sources is extensively exploited to construct the color-message graph. Given a particular product and brand for which a product or product packaging is to be designed, along with the company's desired marketing message, the mechanisms apply computational logic to generate a set of new color palettes that may be used for the product or product packaging design. This process leverages existing color palettes used by similar products of different brands or different products of the same brand, takes in optional color preferences from users, and then identify a set of color palettes to convey a desired marketing message. The mechanisms then rank the set of color palettes based on assessment of their visual aesthetics, novelty and a way that different messages of the same palette interact with each other, so as to guide a final color palette decision.

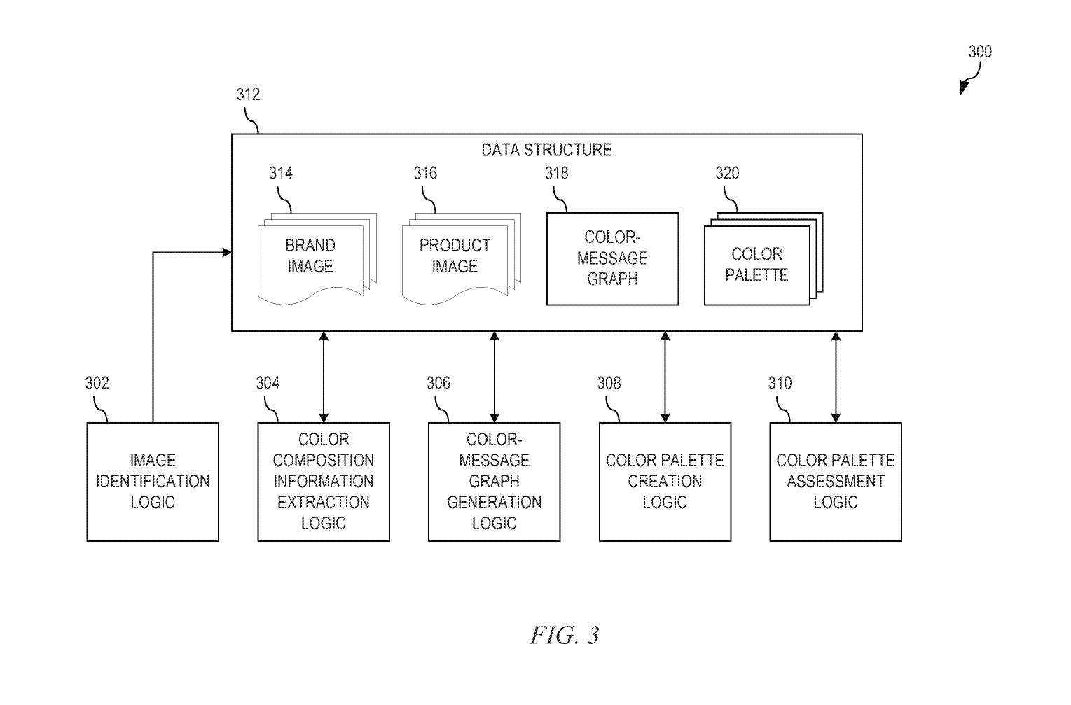

FIG. 3 depicts a functional block diagram of a creative color design mechanism in accordance with an illustrative embodiment. The functional block diagram of FIG. 3 may be implemented, for example, by one or more of the computing devices illustrated in FIG. 1 and/or data processing system 200 of FIG. 2. Creative color design mechanism 300 comprises image identification logic 302, color composition information extraction logic 304, color-message graph generation logic 306, color palette creation logic 308, and color palette assessment logic 310. Image identification logic 302 identifies a large set of images of different brands (B) as well as products (P) as input to creative color design mechanism 300, which image identification logic 302 stores in data structure 312 as brand images 314 and product images 316, respectively. Each image stored in data structure 312 is identified by metadata identifying product and brand. This large set of images is used by creative color design mechanism 300 as inspirations to creatively generate a set of new color palettes 320. Image identification logic 302 may identify the images via interaction with advertisements, product specifications, branding, or the like, from websites, scanned advertisements, television recordings, or the like, accessible via a network such as network 102 of FIG. 1.

Once image identification logic 302 identifies the large set of images, color composition information extraction logic 304 extracts color-related information from one or more identified images. The one or more identified images may be a subset of the large set of images identified based on product selection, brand selection, user predetermined criteria, or the like. Specifically, for each image in the one or more identified images, color composition information extraction logic 304 extracts a set of distinct colors, along with each color's proportion, by applying a multi-resolution color quantization and indexing process. In particular, color composition information extraction logic 304 applies an octree structure-based color quantization approach to cluster and identify distinct colors. That is, in a Red, Green, Blue (RGB) color space or RGB color system, colors are constructed from different combination of Red, Green, and Blue colors. In computer terms, the red, green, and blue colors use 8 bits each, which have integer values from 0 to 255, which makes 256*256*256=16,777,216 possible colors and each possible color has an associated color name. Therefore, in one embodiment, for each identified color from an image, color composition information extraction logic 304 names the color from the 16,777,216 possible colors based on a mapping table of color values (in RGB format) and color names.

In an alternative embodiment, in order to reduce the complexity utilizing 16,777,216 possible colors and associated color names, color composition information extraction logic 304 may utilize a subset of the 16,777,216 possible colors and associated color names. Therefore, color composition information extraction logic 304 may find a closest color in the subset of possible RGB colors based on Euclidean distance in CIE 1976 (L*, u*, v*) color space (CIELUV) color space. That is, CIELUV identifies perceptual uniformity of color when dealing with colored lights. Thus, color composition information extraction logic 304 identifies a color from an image using the octree structure-based color quantization approach to cluster and identify distinct colors in the CIELUV color space and matches each identified color to a closest color in the subset of possible RGB colors based on Euclidean distance. Finally, color composition information extraction logic 304 ranks the colors based on the colors' proportions within the image.

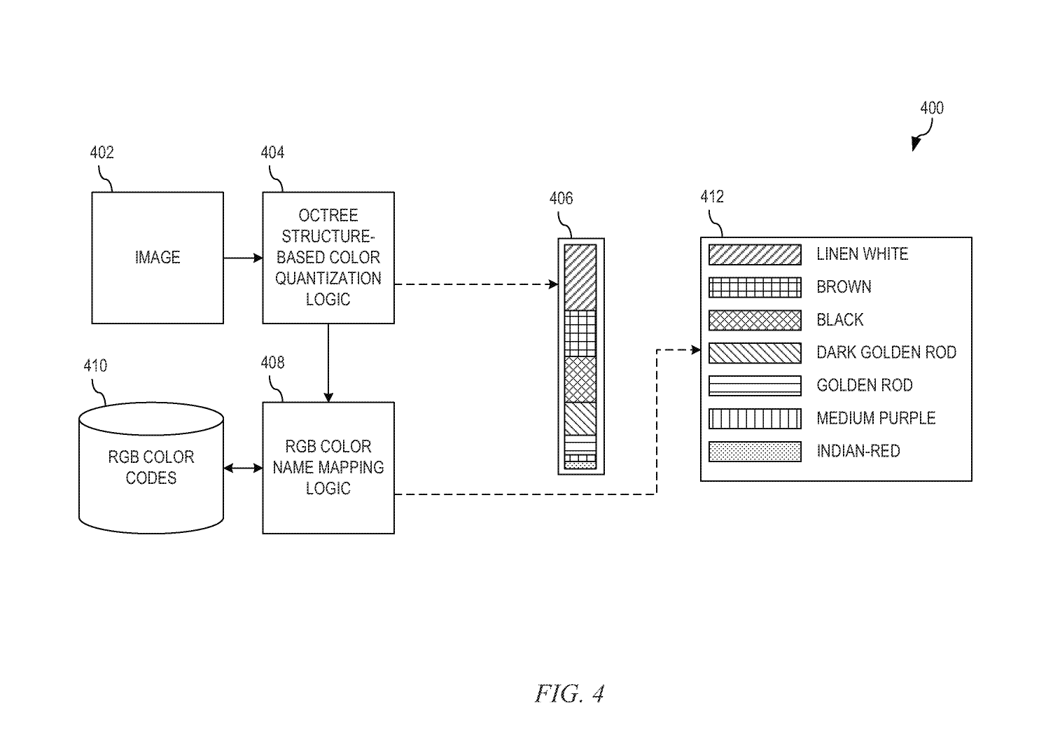

FIG. 4 depicts an example of the color composition information extraction process performed by color composition information extraction logic 304 of FIG. 3 in accordance with an illustrative embodiment. In the example, image 402 is provided as input to the color composition information extraction logic 400. Color composition information extraction logic 400 applies octree structure-based color quantization logic 404 to cluster and identify distinct colors in the CIELUV color space, which results in a set of seven identified colors 406, which are ranked based on proportion of the color within the image. The set of seven identified colors 406 is provided to RGB color name mapping logic 408 to identify a name for each of the set of seven identified colors 406 using a subset of the 16,777,216 possible RGB colors and associated color names stored in RGB color codes data structure 410 based on Euclidean distance. The color to color name identification results in seven color names 412 being identified as associated with the set of seven identified colors 406, such that, in descending proportionality, the colors are identified as linen white, brown, black, dark-golden-rod, golden rod, medium-purple, and indian-red.

Returning to FIG. 3, once the color proportions and color names have been identified for each of the one or more identified images, the color palettes and associated color names are stored along with the associated images for use in generating new creative color designs in data structure 312. Thus, the metadata of each image in data structure 312 is updated with the color proportion of the image as well as the color names. However, in order to generate the new creative color designs, color-message graph generation logic 306 generates a color-message graph 318 so that any new creative color design may be presented along with associated messages related to the colors in the new creative color design. That is, color psychology is the study of color as a determinant of human behavior. A general model of color psychology relies on basic principles such as “color can carry specific meaning, which is either based on learned meaning or biologically innate meaning” and “the perception of a color causes automatic evaluation by the person perceiving, which forces color-motivated behavior.”

While it may be true that color meanings are subjective and vary with people, there are indeed broader messaging patterns to be found in color perceptions. That is, for example, the color yellow and its associated variants are perceived as cheerful and energetic, yet mellow and soft. Just like the mid-summer sunshine, yellow portrays hope, happy times and used as a way to grab one's attention. Orange and its associated variants are friendly, vital, inviting, energetic, and playful color. Orange is perhaps the hottest of all colors, which is why almost everyone can relate to the color orange in some way or another, especially children. Red and its associated variants excite, stimulate, and create arousal. People often think of the color red as daring, warm, dynamic, bold, and sexy. In print, red is an aggressive color, whereas the color red commands attention and demands action. Green and its associated variants are the color of nature, and everything that goes with it. The color green has been described as refreshing, healing, soothing, and prestigious (when associated with money and banks). Purple and its associated variants reflect elegance, sensuality, spirituality, and creativity. Purple is perhaps the most complicated and rare color, hence referred to as a majestic and royal, fit for kings. Brown and its associated variants are the ultimate traditional earth colors, associated with substance, durability, and security. The color brown's earthly tones lend perfectly to food and food related items, even used in restaurants and coffee houses. Black and its associated variants are strong, classic, mysterious, and powerful. The most sophisticated shade of the spectrum, people associated the color black with style, elegance, and expensive taste.

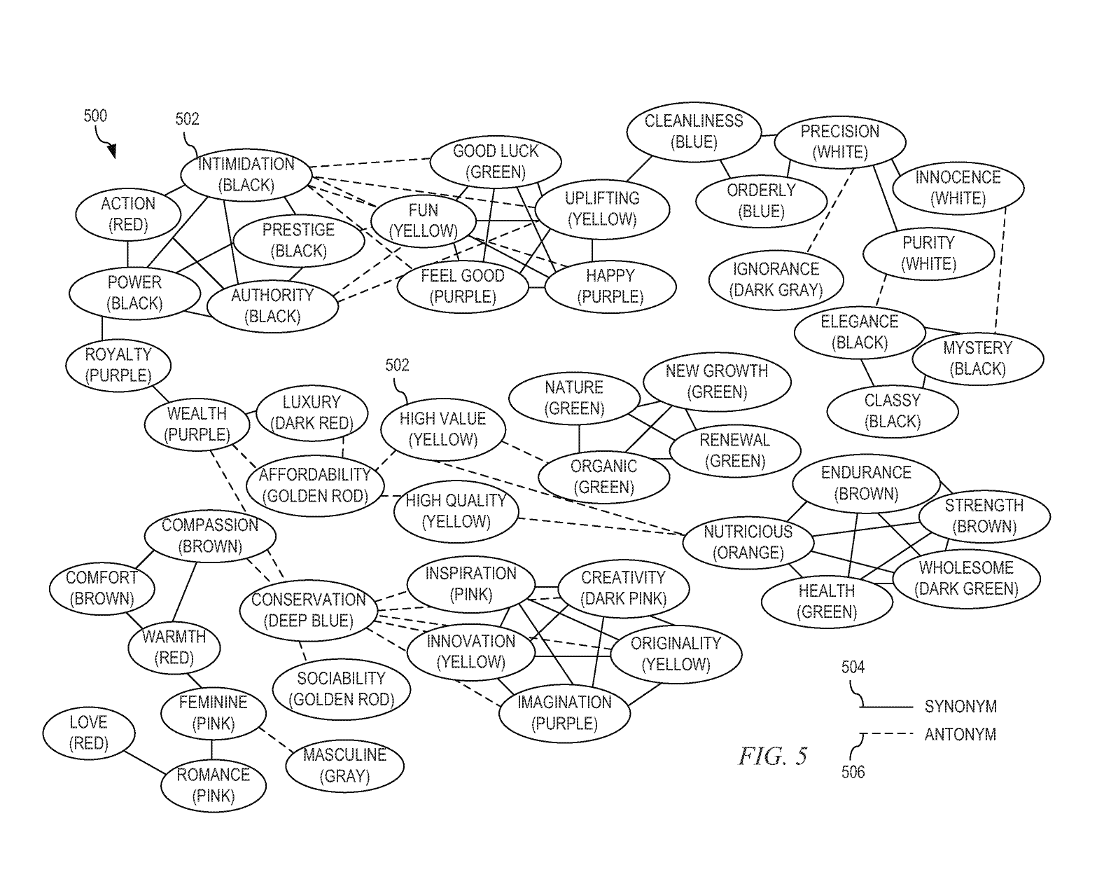

Thus, color-message graph generation logic 306 generates a color-message graph 318 based on prior study on color psychology, that contains colors, a message associated with each color, and a relationship between messages expressed as synonym links or antonym links in the color-message graph 318, which may be referred to as ontology. Color-message graph generation logic 306 stores the generated color message graph 318 in data structure 312. FIG. 5 depicts one example of a color-message graph in accordance with an illustrative embodiment. As is illustrated, for each color and its associated message 502 in color-message graph 500, color-message graph generation logic 306 of FIG. 3 generates a synonym relationship 504 indicated by a solid line or an antonym relationship 506 indicated by a dashed line to another color and its associated message 502.

As an example of the ontology illustrated in color-message graph 500, creativity and innovation are synonyms, while adventure and security are antonyms. Thus, color-message graph 500 illustrates a message ontology that identifies relationships among messages according to certain knowledge sources, such as, for example, a thesaurus. As would be evident to one of ordinary skill in the art, with there being at least 16,777,216 possible colors, color-message graph 500 presents a subset of colors and their associated messages, which may be limited to only those colors associated with the one or more identified images in data structure 312 extracted by color composition information extraction logic 304. Thus, color-message graph 500 is one example of a color-message graph that may be employed by creative color design mechanism 300.

Returning to FIG. 3, once the color proportions and color names have been identified for each of the one or more identified images and the color-message graph has been generated, color palette creation logic 308 analyzes one or more of the images to identify color statistics. Specifically, color palette creation logic 308 receives three inputs including a targeted product, a targeted brand, and a targeted brand message(s). For example, the design task could identify “Design a cereal product package for Quaker which conveys fun and nutritiousness messages.” Other parameters, such as the targeted customer segments or countries may also be received as inputs, but are not part of the following description.

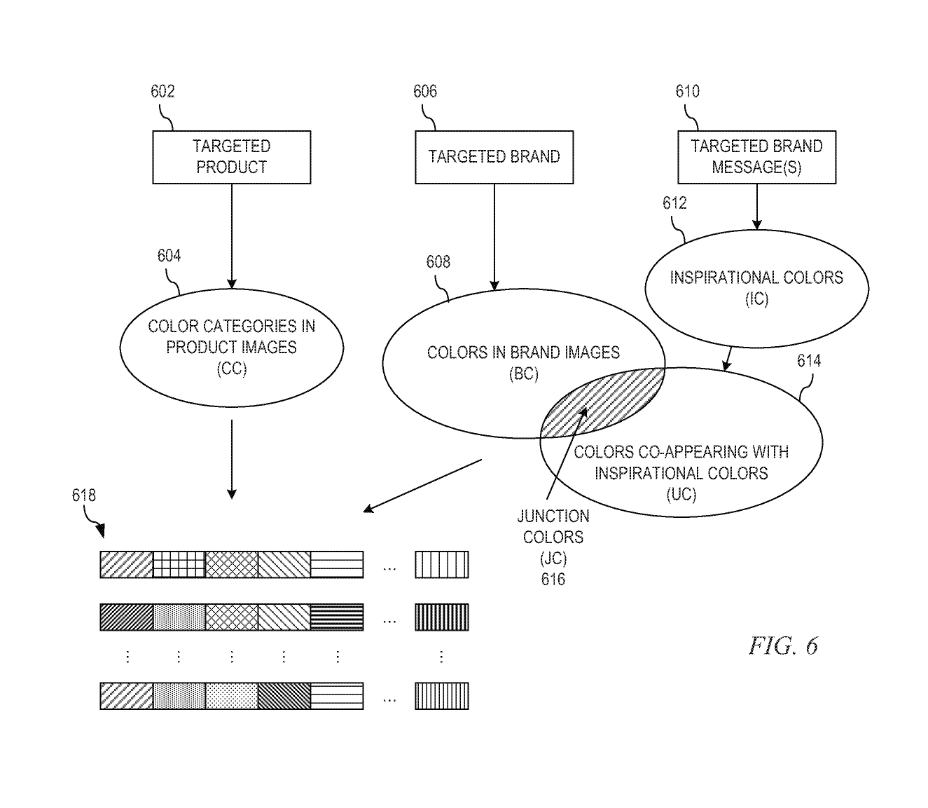

FIG. 6 depicts an exemplary operation performed by color palette creation logic 308 in generating the set of new color palettes 320 in accordance with an illustrative embodiment. In generating the set of new color palettes 320, color palette creation logic 308 implements statistical analysis of colors from various image sets. In staying with the above example, given the targeted product 602 (i.e., “cereal”), color palette creation logic 308 identifies a set of color categories (CC) 604 that exist in all cereal product images in data structure 312, based on the pre-extracted color composition information analyzed by color composition information extraction logic 304. In accordance with the illustrative embodiments, color category describes a type or name of a color such as red or black. Therefore, a category of red may comprise of a whole range of red colors of different shades and tints. Color palette creation logic 308 then ranks all of the identified color categories associated with the targeted product based on a frequency of their occurrence. Next, given the targeted brand 606 (i.e., “Quaker”), color palette creation logic 308 identifies a set of brand colors (BC) 608 that exist in all images in data structure 312 of Quaker products. Color palette creation logic 308 represents each color by its RGB values and associates the RGB values with frequency of occurrence, thereby identifying signature colors of the targeted brand.

Given the targeted brand message(s) 610, color palette creation logic 308 identifies the representative colors associated with the targeted brand message(s) 610 from the color-message graph generated by color-message graph generation logic 306. That is, utilizing one or more words in the targeted brand message(s), color palette creation logic 308 identifies the colors associated with those one or more words. For example, with the targeted message of “fun and nutritiousness,” color palette creation logic 308 would identify the colors “yellow” and “orange.” Color palette creation logic 308 refers to the identified colors as a set of inspirational colors (IC) 612. Each inspirational color is assigned to a color category and is denoted as ψ={IC₁, . . . , IC_{P}}). Then, utilizing all images in data structure 312, color palette creation logic 308 identifies colors that have co-appeared with at least one of the inspirational colors (IC) 612 and denote them as a set of universal colors (UC) 614. Again, color palette creation logic 308 represents each color by RGB values and associates a frequency of occurrence with that color in order to find colors that will potentially go well with the set of inspirational colors (IC) 612.

Color palette creation logic 308 then identifies an intersection of the set of brand colors (BC) 608 and the set of universal colors (UC) 614, which is denoted as a set of junction colors (JC) 616. The weight of each color in the set of junction colors (JC) 616 equals the product of the color's frequency of occurrence in both the set of brand colors (BC) 608 and the set of universal colors (UC) 614. Color palette creation logic 308 then assigns each of the set of junction colors (JC) 616 to a color category, and sorts all colors in each category based on their weights in a descending order. These colors will be eventually used to generate the new color palettes 618. An example output of this step could be that the Red category contains 300 different red colors listed in a ranked order in order to identify colors that are both popularly used by the brand images (i.e., the set of brand colors (BC) 608) and go well with the set of inspirational colors (IC) 612.

The basic idea of generating the one or more new color palettes 618 is to use the set of color categories (CC) 604 and the set of inspirational colors (IC) 612 as the inspiration, take optional color preferences from the user, and leverage all possible signature colors from the set of brand colors (BC) 608 that will go well with the set of inspirational colors (IC) 612, i.e., the set of junction colors (JC) 616. In order to generate creative color palettes, color palette creation logic 308 obtains users' preferences on color categories in the set of color categories (CC) 604. Users may decide which color categories to use with how many colors. For instance, they could choose to have two types of blue colors in the design. By default, color palette creation logic 308 selects the top N categories based on their occurrence frequency if no user input is given, where N indicates the mode of category distribution.

The number of colors used in a product or product package would ultimately affect its marketing message. For instance, through experiments, the majority of shampoo products use 3 colors, while many cereal boxes have up to 8 colors on them. Such differences may impact the branding messages of these two products where companies market shampoo products to be “elegant and sophisticated,” while other companies market cereal products to be “fun and cheerful.” Consequently, with or without user input, color palette creation logic 308 generates a set of selected color categories as φ={CC₁, CC₂, . . . , CC_{N}}. Note that if a user has specified more than one color for each category (for example, two), color palette creation logic 308 simply splits that category into two categories, so as to ease the subsequent palette generation process.

Color palette creation logic 308 then merges the set of selected color categories φ with the color categories of the inspirational colors ψ, removes the duplicates, and denotes the obtained color categories as Ψ={CC₁, CC₂, . . . , CC_{N}, . . . CC_{N+P}}, which is used for generating new color palettes. Specifically, the color palette creation logic 308 generates one corresponding color for each color category. For instance, if CC₁ is “red,” then color palette creation logic 308 generates a red color (for example, RGB(200, 20, 10)). Once color palette creation logic 308 generates the corresponding RGB color for each category in Ψ, color palette creation logic 308 creates a new color palette.

Then, for each color category CC and a color category immediately following the color category CCᵢ₊₁ from Ψ, color palette creation logic 308 takes the top M colors of each category from the set of junction colors (JC) 616 as the candidates and performs a set of color combinations that results in one or more new color palettes 618. For each color palette combination, color palette creation logic 308 determines a weight that is an average of a weight of each color component. Since JCᵢ is a set of ranked colors falling under color category CCᵢ, with |JCᵢ| being the cardinality of JCᵢ, there may be |JC₁|×|JC₂|× . . . ×|JC_{N}| possible color combinations for generating the one or more new color palettes 618.

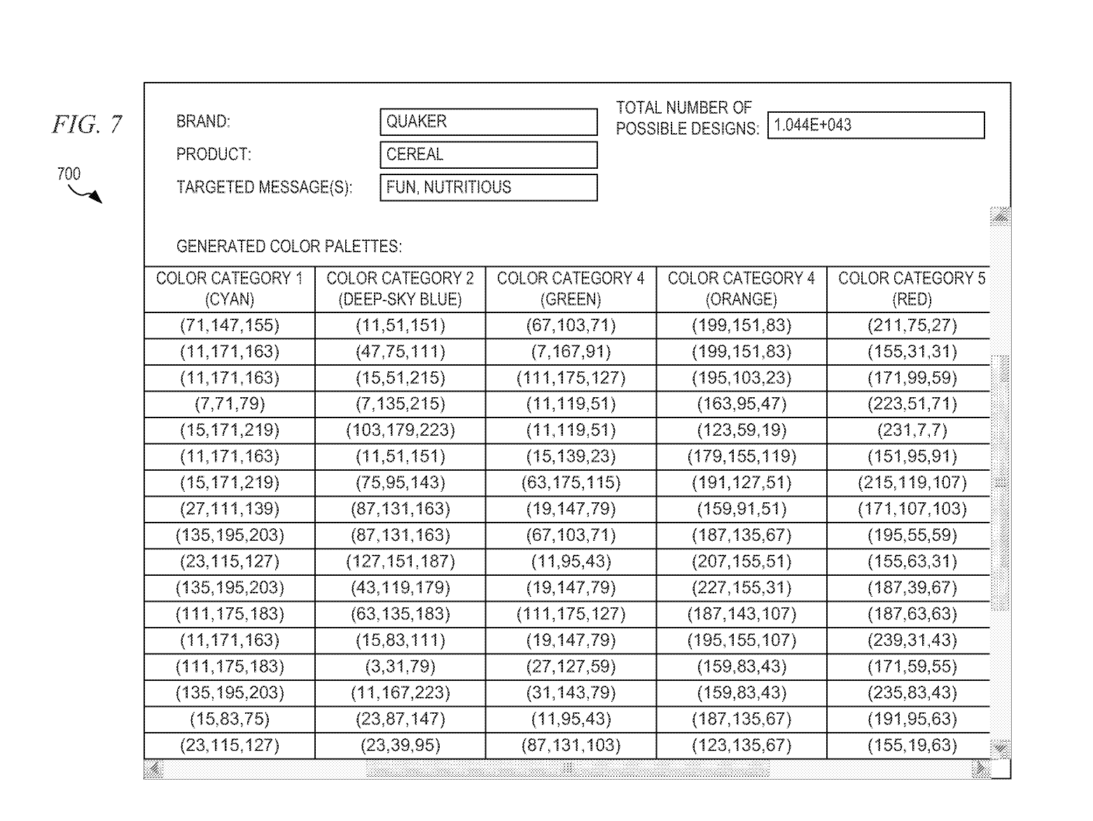

Therefore, in order to prune the color combination possibilities, color palette creation logic 308 retains the combinations whose weights are above a certain threshold T_{w} and discards the combinations that are equal to or below the threshold T_{w}. After pruning by weight, if the total number of remaining combinations is greater than a combination threshold T_{c}, color palette creation logic 308 randomly samples combinations from the remaining combinations in order to further prune the combinations. Thus, color palette creation logic 308 outputs a final set of color combinations as the generated one or more new color palettes 618, where each color in a combination is expressed as an RGB format. Color palette creation logic 308 stores each of the generated color palettes as the set of new color palettes 320 in data structure 312. FIG. 7 depicts one example of the possible color combinations 700 that are generated by the color palette creation logic 308 in accordance with an illustrative embodiment.

Returning to FIG. 3, once color palette creation logic 308 has generated the set of new color palettes 320, color palette assessment logic 310 generates a set of metrics to assist users to choose a desired color palette from the new color palettes. These metrics assess the aesthetics and novelty of each color palette in the set of new color palettes 320, as well as exploring how different messages conveyed by the same palette interact with each other.

In one embodiment, color palette assessment logic 310 assesses the aesthetics or visual appeal of a color palette by measuring its colorfulness and color spreadness. Colorfulness measures the perceived intensity of colors in the palette to human eyes. The higher the color intensity, the more the colorfulness of a palette. Specifically, color palette assessment logic 310 measures the colorfulness in an opponent color space, by first calculating the difference values between the red and green color components and the difference between the red, green, and blue color components for each color in a palette. Then, color palette assessment logic 310 calculates the mean and standard deviation of these difference values and subsequently evaluates the mean and standard deviation to obtain the colorfulness metric. Color spreadness measures how widely colors are spread across a color wheel. A large color spreadness score for a given color palette indicates that the color palette has a good variety of colors. Specifically, color palette assessment logic 310 measures the color spreadness as the average Euclidean distance between every pair of colors in a palette. Generally speaking, the larger the score of the colorfulness and the color spreadness, the more appealing the color palette is.

Note that the interpretation of these two measures is very specific to product and market. For instance, if the product is targeted for children, then using a palette with high scores of colorfulness and spreadness may be a good idea as that will make the product look fun and cheerful. Nevertheless, if the targeted customer segment is professionals, then a product with a fewer neutral colors such as black, gray, and silver, may be more appropriate.

In another embodiment, color palette assessment logic 310 assesses a surprise factor for the color palette. That is, a product that is novel should be unusual, surprising, has a wow factor, and change the observer's view. Novelty may be quantified by considering a prior probability distribution of existing products and the change in that probability distribution after the new product is observed, i.e. the posterior probability distribution. Color palette assessment logic 310 calculates this surprise factor by calculating the Bayesian surprise, which empirically captures human notions of novelty and saliency across different modalities and levels of abstraction. Color palette assessment logic 310 calculates the cognitively-inspired Bayesian surprise as follows:

$$\begin{matrix}Bayesian surprise = D ( p ( M \vert A ) \vert \vert p ( M ) ) \\ = {\int }_{Mo} p ( M \vert A ) log ( p ( M \vert A ) \text{/} p ( M ) ) d M\end{matrix}$$

where M indicates a set of artifacts known to the user with each artifact in this repository being MεMₒ. Also, A denotes a new artifact that is observed. p(M) indicates a probability of an existing artifact, and p(A|M) is a conditional probability of the new artifact A given the existing artifact p(M). Via Bayes' theorem the conditional probability of the existing artifacts given the new artifact is p(M|A). Thus, color palette assessment logic 310 assess how novel a color palette is, where the new artifact A refers to the colors in the color palette, and M indicates all colors that have been previously used by images of the targeted product in data structure 312.

Since a color palette likely consists of multiple colors and thereby conveying multiple messages, in yet another embodiment, color palette assessment logic 310 determines how the messages interact with each other and especially how they comply with the targeted brand message(s). In order to determine the message interactions, color palette assessment logic performs a compliance analysis by checking all relationships between messages represented by the colors in a palette according to the color-message graph 318, for which one example is illustrated in FIG. 5. Color palette assessment logic 310 identifies two sets of messages where the first one contains those that are synonymic to the brand messages, while the other one is for antonymic messages.

For instance, given the exemplary targeted message of being “fun and nutritious,” color palette assessment logic 310 identifies synonymic or reinforcing messages such as feel-good, happy, uplifting, and good-luck, which are consistent with fun. On the other hand, color palette assessment logic 310 also identifies antonymic or contrasting messages such as intimidation, prestige, and authority. Note that, whether it is a good or bad idea to have conflicting messages coming from the same color palette, ultimately it is up to human designers' decisions as to which color palette will be selected. The mechanism of the illustrative embodiments are numerous color palettes from which the user may decide, with each color palette having one or more of a colorfulness score, a color spreadness score, synonymic or reinforcing messages, or antonymic or contrasting messages.

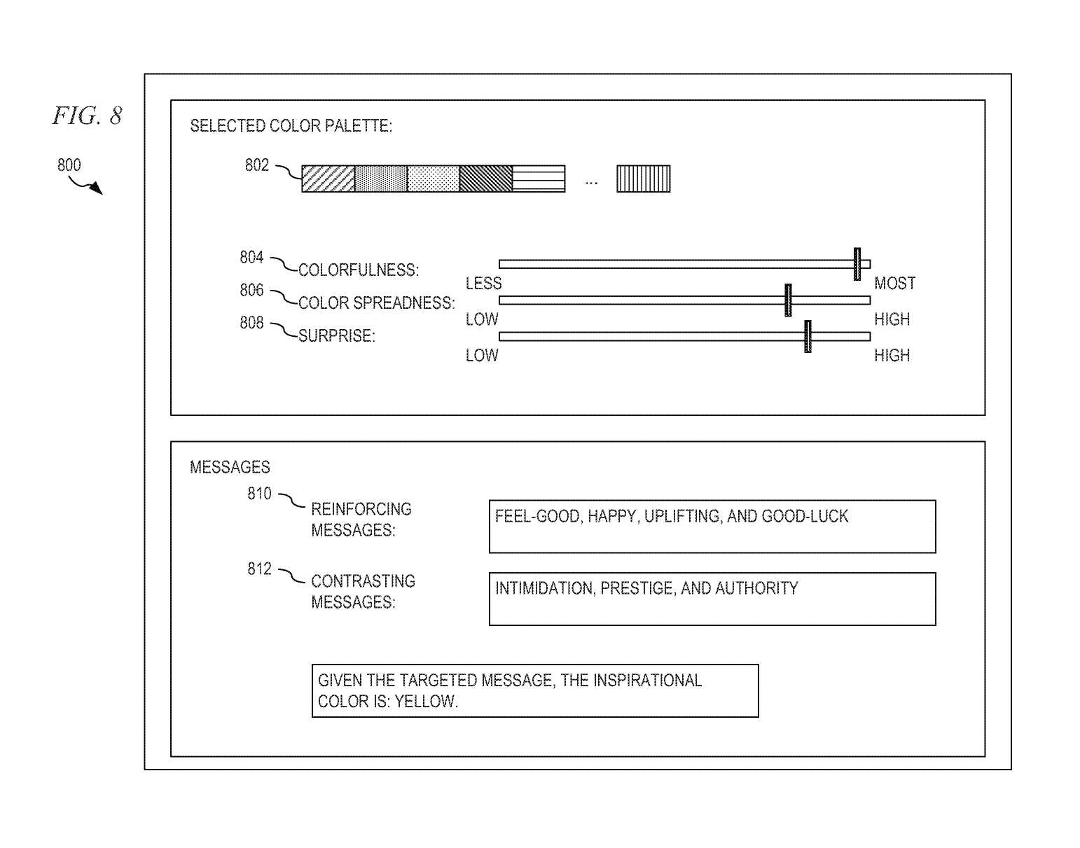

FIG. 8 depicts one example of the color analysis associated with a selected color palette such as those shown in FIG. 7 in accordance with an illustrative embodiment. As is shown in color analysis 800, for a selected color palette 802, an indication of the colorfulness 804, color spreadness 806, and surprise 808 is provided along with synonymic or reinforcing messages 810 and antonymic or contrasting messages 812.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

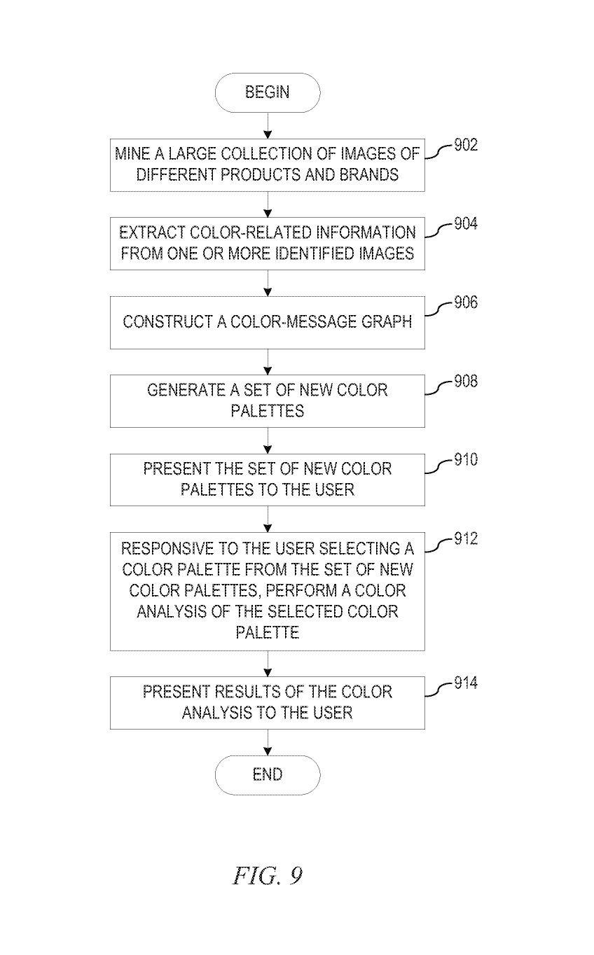

FIG. 9 depicts a flowchart of the operation performed by the creative color design mechanism in accordance of the illustrative embodiments. As the operation begins, the creative color design mechanism mines a large collection of images of different products and brands to learn about all the colors and color combinations that frequently appear among the products and brands (step 902), the brand and product information of each image stored as metadata with the image. The creative color design mechanism extracts color-related information of each image from one or more identified images (step 904), the color-related information being stored as information with the image. The creative color design mechanism constructs a color-message graph to represent messages conveyed by colors detected in the one or more identified images as well as to capture the interrelationship among the messages (step 906), such as synonymic and antonymic interrelationships.

Given a targeted product, brand, and message to be marketed, the creative color design mechanism applies computational logic to generate a set of new color palettes that may be used for the product or product packaging design (step 908). The creative color design mechanism then presents the set of new color palettes to the user (step 910). Responsive to the user selecting a color palette from the set of new color palettes, the creative color design mechanism performs a color analysis of the selected color palette (step 912), the color analysis including one or more of a colorfulness, a color spreadness, a surprise factor, a reinforcing message, or a conflicting message. The creative color design mechanism presents results of the color analysis to the user (step 914), with the operation terminating thereafter.

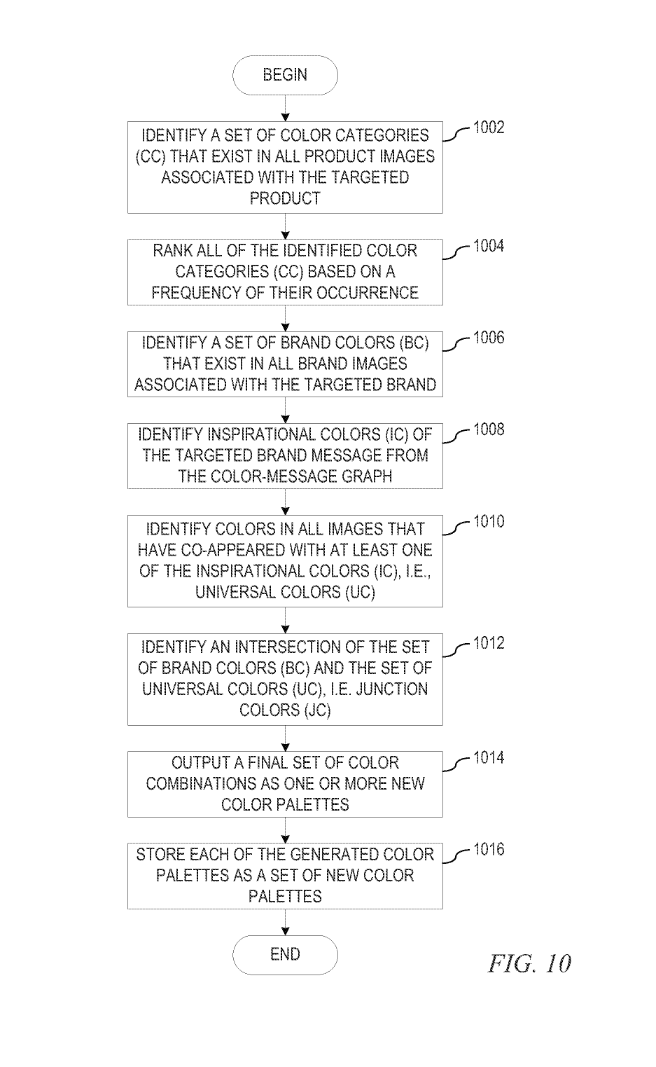

FIG. 10 depicts a flowchart of the operation performed by the creative color design mechanism in generating the set of new color palettes in accordance of the illustrative embodiments. As the operation begins, the creative color design mechanism identifies a set of color categories (CC) that exist in all product images associated with the targeted product (step 1002), based on the pre-extracted color composition information. The creative color design mechanism ranks all of the identified color categories (CC) associated with the targeted product based on a frequency of their occurrence (step 1004). Given the targeted brand, the creative color design mechanism identifies a set of brand colors (BC) that exist in all brand images associated with the targeted brand (step 1006), where the creative color design mechanism represents each color by its RGB values and associates the RGB values with frequency of occurrence, thereby identifying signature colors of the targeted brand.

Given a targeted brand message(s), the creative color design mechanism identifies the representative colors of the targeted brand message(s) from the color-message graph (step 1008), which the creative color design mechanism refers to as a set of inspirational colors (IC). Utilizing all collected images, the creative color design mechanism identifies colors in all images that have co-appeared with at least one of the inspirational colors (IC) and denotes them as a set of universal colors (UC) (step 1010), which the creative color design mechanism represents by RGB values. The creative color design mechanism then identifies an intersection of the set of brand colors (BC) and the set of universal colors (UC) (step 1012), which the creative color design mechanism denotes as a set of junction colors (JC). Utilizing the set of color categories (CC) and the set of inspirational colors (IC) as the inspiration, taking optional color preferences from users, and leveraging the set of junction colors (JC), the creative color design mechanism outputs a final set of color combinations as one or more new color palettes (step 1014), where each color in a combination is expressed as an RGB format. The creative color design mechanism stores each of the generated color palettes as a set of new color palettes (step 1016), with the operation terminating thereafter.

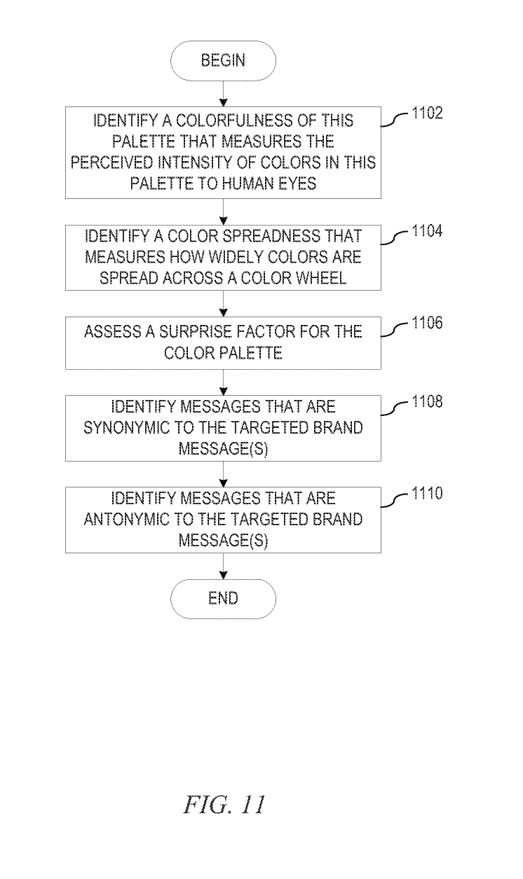

FIG. 11 depicts a flowchart of the operation performed by the creative color design mechanism in analyzing the set of new color palettes in accordance of the illustrative embodiments. As the operation begins, responsive to the user selecting a color palette from the set of new color palettes, the creative color design mechanism identifies a colorfulness of this palette that measures the perceived intensity of colors in the palette to human eyes (step 1102). Specifically, the creative color design mechanism measures the colorfulness in an opponent color space, by first calculating the difference values between the red and green color components and the difference between the red, green, and blue color components for each color in the palette. Then, the creative color design mechanism calculates the mean and standard deviation of these difference values and subsequently evaluates the mean and standard deviation to obtain the colorfulness metric. The creative color design mechanism then identifies a color spreadness of the palette that measures how widely colors are spread across a color wheel (step 1104). Specifically, the creative color design mechanism measures the color spreadness as the average Euclidean distance between every pair of colors in the palette. Therefore, the larger the score of the colorfulness and the color spreadness, the more appealing the color palette is.

The creative color design mechanism assesses a surprise factor for the selected color palette by calculating the cognitively-inspired Bayesian surprise (step 1106). Since a color palette likely consists of multiple colors and thereby conveying multiple messages, in yet another embodiment, the creative color design mechanism determines how the messages interact with each other and especially how they comply with the targeted brand message(s). In order to determine the message interactions, color palette assessment logic performs a compliance analysis by checking all relationships between messages represented by the colors in a palette according to the color-message graph. Therefore, the creative color design mechanism identifies two sets of messages where the first one comprises messages that are synonymic to the targeted brand message(s) (step 1108), while the other one comprises messages that are antonymic to the targeted brand message(s) (step 1110), with the operation terminating thereafter.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for generating numerous new color palette possibilities and identify smaller sets of color palettes for the design of new and/or existing products based on the measures of spreadness, colorfulness, and surprise. Based on the colors contained in each color palette, a determination is made as to whether the messages being conveyed by the color palette is consistent or conflicting with the desired brand message. This determination is established using a rich network of relationships between messages and colors based on color psychology.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system, for generating a set of color palettes for a product, the method comprising:
extracting, by a processor in the data processing system, color-related information of each image in a set of images;
using a user provided targeted product, targeted brand, and targeted brand message(s) to be marketed, applying, by the processor, computational logic to generate a set of new color palettes for use in product design or product packaging design;
presenting, by the processor, the set of new color palettes to the user;
responsive to the user selecting a color palette from the set of new color palettes, performing, by the processor, a color analysis of the selected color palette; and
presenting, by the processor, results of the color analysis to the user.

2. The method of claim 1, wherein the set of images are images of different products and brands that are mined, by the processor, to learn about all colors and color combinations that frequently appear among the products and the brands.

3. The method of claim 1, wherein applying the computational logic to generate the set of new color palettes for use in the product design or the product packaging design further comprises:
identifying, by the processor, a set of color categories (CC) that exist in product images associated with the targeted product;
identifying, by the processor, a set of brand colors (BC) that exist in brand images associated with the targeted brand;
identifying, by the processor, a set of inspirational colors (IC) of the targeted brand message(s) from a color-message graph;
utilizing the set of images, identifying, by the processor, a set of universal colors (UC) that have co-appeared with at least one of the inspirational colors (IC);
identifying, by the processor, an intersection of the set of brand colors (BC) and the set of universal colors (UC) thereby forming a set of junction colors (JC); and
utilizing the set of color categories (CC) and the set of inspirational colors (IC) as the inspiration, taking optional color preferences from the user, and leveraging the set of junction colors (JC), outputting, by the processor, a final set of color combinations as the set of new color palettes.

4. The method of claim 3, wherein the color-message graph is constructed to represent messages conveyed by colors detected from the set of images, wherein the color-message graph captures an interrelationship among the messages, and wherein the interrelationship is at least one of an synonymic relationship or an antonymic relationship.

5. The method of claim 3, wherein the set of new color palettes are generated by randomly selecting a top color from the set of junction colors (JC) that fall into each of color category (CC) in the set of color categories (CC), and subsequently performing combinations and pruning.

6. The method of claim 1, wherein performing the color analysis of the selected color palette further comprises:
identifying, by the processor, a colorfulness that measures the perceived intensity of colors contained in the selected color palette to human eyes.

7. The method of claim 1, wherein performing the color analysis of the selected color palette further comprises:
identifying, by the processor, a color spreadness that measures how widely colors in the selected color palette are spread across a color wheel.

8. The method of claim 1, wherein performing the color analysis of the selected color palette further comprises:
assessing, by the processor, a surprise factor for the selected color palette, wherein assessing the surprise factor is performed by calculating a cognitively-inspired Bayesian surprise.

9. The method of claim 1, wherein performing the color analysis of the selected color palette further comprises:
identifying, by the processor, a set of synonymic messages to the targeted brand message(s) using a color-message graph.

10. The method of claim 1, wherein performing the color analysis of the selected color palette further comprises:
identifying, by the processor, a set of antonymic messages to the targeted brand message(s) using a color-message graph.

11-20. (canceled)
